(19) United States
(12) Patent Application Publication
(10) Pub. No.: US 2010/0031657 A1
(43) Pub. Date: Feb. 11, 2010

(54) Jet propelled flywheel

(76) Inventor: Richard Eastwood Page, JR., Aberdeen, NC (US)

Correspondence Address: Lt. Col. Richard E. Page, Jr., P O Box 342/240 Allison Page Road, Aberdeen, NC, 28315-0342, US

(21) Appl. No.: 12/157,965

(22) Filed: Jun. 16, 2008

(51) Int. Cl. F03G 7/10

(52) U.S. Cl. 60/721; 74/DIG. 9

(57) ABSTRACT

Jet propulsion of the flywheel is accomplished by introducing a fluid (synthetic lubricant) into the hollow shaft at the center of the flywheel. Centrifugal force carries the fluid through holes to the rim. Thus enhanced, it is now forced through a nozzle. Fluid jets opposite and tangential to the rotation of the flywheel sustain or increase the rotational speed of the flywheel. Jetted fluid is collected and re-circulated through the flywheel. This is a continuous self-perpetuating process, requiring no fossil fuel and involves no release to the environment. It can provide power on the moon, planets, or anywhere there is gravity.

The fundamental operating principles of the flywheel and any jet propulsion device are founded on the three laws of motion formulated by Sir Isaac Newton in 1687.

The principle generally known as Newton's Third Law of Motion states that to every action there is an equal and opposite reaction.¹ ¹ Maurice J. Zucrow, Principles of Jet Propulsion and Gas Turbines, Third Printing, 1951, New York, John Wiley & Sons, Inc.

By combining jet propulsion and the flywheel, I have discovered new laws of motion for the combination. The flywheel generates centrifugal force, which in turn powers the jet propulsion, which in turn increases the RPM of the flywheel, a self perpetuating process.

The new laws of motion are:
I. As the RPM increases linearly the centrifugal force increases exponentially to the power of two.
II. As the RPM increases linearly the stored energy increases exponentially to the power of four.

To evaluate the potential of the jet propelled flywheel, I selected a 10″ diameter by 3″, thick flywheel. This establishes an 11,458 maximum safe RPM.^{2 3} ² Machinery's Handbook, 17^{th} Edition, 1964, Third Printing, The Industrial Press, New York³ Machinery's Handbook 28^{th} Edition, 2008, The Industrial Press, New York

I chose from 1000 to 11,000 RPM intervals and calculated centrifugal force at each. I was surprised and excited to see that the values increased progressively and significantly. To quantify these values, I divided the value at F₁ (centrifugal force at 1000 RPM), 8,711 ft-lbs, into the value at F₂, 34,844 ft-lbs, and was astounded by the answer, single digit 4! An answer of 9 at 3000 RPM and of 16 at 4000 RPM told me I had a new law of motion for a jet propelled flywheel. I was elated and the background heard Sir Isaac laughing and saying “Okay, Dummy, you are finally on track.” Note: Numbers here are different from numbers in Table 1 due to using 5 inches for radius rather than 0.417 feet for calculations.

The flywheel with a hollow shaft, holes to carry the fluid from the center to the rim and through nozzles which eject it tangentially opposite the direction of rotation (literally flinging the fluid from the wheel in jets directed so as to rotate the wheel). The fluid is then collected and returned up the hollow shaft to the center. This becomes a continuous, self-perpetuating process, no fuel, no releases. A new source of energy!

Attachments 1 and 2 show data on the 10 inch×3 inch flywheel. Increasing the flywheel to 10 inch×6 inch will double the values at each RPM value. Numbers shown in Table 1 are not likely to be attainable at the higher RPM levels.

I plan a prototype rotating at mid-range, 4000 RPM. A single design of flywheel will cover a whole range of power levels depending on RPM.

An ideal constant load would be a generator connected by centrifugal or magnetic clutch. Ideal positioning would be gyroscopic to self-align with earth's axis and gimbal mounted if in a moving vehicle. A vacuum chamber for the flywheel may be needed.

This is remarkably similar to a nuclear chain reaction (without the fissionable isotope) which is also a self-perpetuating process—useful when under control in a nuclear reactor. When Erico Fermi demonstrated the first chain reaction on a squash court, under the stands at University of Chicago in 1939, he also established a reactor as a source of control for the peaceful use of nuclear power. Similar control of the jet propelled flywheel will be needed.

The jet-propelled flywheel is simple and straight forward. The 10 inch diameter by 3 inch thick flywheel is fitted with a hollow shaft and three ½″ to ¾″ holes drilled 60 degrees apart, near the middle of the rim, all the way through the wheel and shaft. Six nozzles fasten into the holes at the rim. (See Attachment 4.)

### ATTACHMENTS

Attachment 1: Table of Calculated Values of Centrifugal Force for 1,000 to 11,000 RPM for a 10″×3″ Flywheel
Attachment 2: Graph of above
Attachment 3: Page 196, Reference 3, Table 5 Factors C
Attachment 4: Page 42, FIG. 3, Reference 1, Nozzle Description

1. I claim the invention of a jet propelled flywheel.
I claim this combination capable of creating its own energy—storing and releasing energy, therefore, discovery of a new source of energy. It can operate continuously without fuel and with no releases to the environment.
I claim discovery of two new laws of motion for the jet propelled flywheel:
I. Linear increases in RPM result in exponential increases in centrifugal force to the power of 2.
II. Linear increases in RPM result in exponential increases in energy to the power of 4.
I claim this as a portable source of free energy. One each for the home, business and transportation could supply individual needs as an alternate to the massive and costly systems for use of fossil fuels we now have and without the adverse environmental effects.
By combining principles of the flywheel and jet propulsion, I have reversed the roles. Instead of an internal combustion engine propelling a flywheel, the flywheel now propels itself, eliminating the need for the IC engine. A high pressure system for lubricating an IC engine will work perfectly well to recirculate the synthetic lubricant through the flywheel, to start the flywheel turning and to limit the rotation of the flywheel to a safe RPM. No fossil fuel, no effect on the environment! A perfect solution to the worlds' oil problem.
